(19) United States
(12) Patent Application Publication
(10) Pub. No.: US 2026/0016033 A1
(43) Pub. Date: Jan. 15, 2026

(54) CONNECTING ELEMENT FOR CONSTRUCTING A T-SHAPED COMPOSITE

(71) Applicant: Thor Tech, Inc., Elkhart, IN (US)

(72) Inventors: Michael Schroll, Kisslegg (DE); Christian Borgenheimer, Warthausen (DE)

(73) Assignee: Thor Tech, Inc., Elkhart, IN (US)

(21) Appl. No.: 19/259,325

(22) Filed: Jul. 3, 2025

(30) Foreign Application Priority Data
Jul. 9, 2024 (DE) 10 2024 119 469.3

(51) Int. Cl. F16B 5/06

(52) U.S. Cl. CPC F16B 5/0614

(57) ABSTRACT

The invention relates to a connecting element for constructing a T-shaped composite of three plates comprising a first contact surface coupled to a rear outer surface of a first plate, a second contact surface coupled to a rear outer surface of a second plate, and a coupling element coupled to the first and second contact surfaces, in an angled manner. The coupling element produces a positive connection between a front outer surface of an edge of the first plate and a rear outer surface of an edge of a third plate, when the third plate is coupled by means of a web which connects a front outer surface of the third plate to a front outer surface of the second plate, in order to arrange the front outer surface of the first plate in alignment with a rear outer surface of the third plate in the T-shaped composite.

### CROSS-REFERENCE TO RELATED APPLICATIONS

This application claims priority to German application No. 10 2024 119 469.3 filed Jul. 9, 2024, the disclosure of which is hereby incorporated by reference in its entirety.

### FIELD

The present invention relates to a connecting element for constructing a T-shaped composite of three plates, and a use of a connecting element for the T-shaped coupling of three plates.

### BACKGROUND

Vehicles with living areas, such as mobile homes or caravans, regularly use lightweight panels for their interiors. These plate elements are used, for example, for furniture parts or as cladding elements and can be provided with different decorations. In this case, those plate elements or layered composite plates that have a sandwich structure with a core material between two outer cover layers have proven to be particularly advantageous. Due to the sandwich structure, such layered composite plates can have a lightweight core material which is arranged between the two cover layers in order to provide high stability with a low surface weight. In this case, the respective top layers can allow for different decorations.

### SUMMARY

For an attractive T-shaped joining of such plates for installation in a vehicle, in particular in the living area of a vehicle, a connecting element is to be provided which can replace typical separating profiles and can arrange three such plates in a T-shape, in particular as closely as possible to one another.

The present invention solves the problem according to the independent claims with a connecting element for constructing a T-shaped composite of three plates and a use of a connecting element for the T-shaped coupling of three plates. Further embodiments can be found in the description, the dependent claims and the figures.

According to a first aspect of the present invention, a connecting element for constructing a T-shaped composite of three plates is proposed, the connecting element having a first contact surface, a second contact surface and a coupling element. In this case, the first contact surface of the connecting element is designed to be mechanically coupled to a rear outer surface of a first plate of the three plates. Furthermore, the second contact surface of the connecting element is configured to be mechanically coupled to a rear outer surface of a second plate of the three plates. The coupling element is mechanically coupled to the first contact surface and the second contact surface. The coupling element is configured to mechanically couple the first plate to the second plate by means of the first contact surface and the second contact surface in an angled manner, in particular substantially at right angles. Furthermore, the coupling element is designed to produce a positive connection between a front outer surface of an edge of the first plate and a rear outer surface of an edge of a third plate when the third plate is mechanically coupled by means of a web which connects a front outer surface of the third plate to a front outer surface of the second plate, in particular in an angled manner.

In this case, the third plate can preferably be arranged at an angle relative to the second plate, substantially at a right angle. The connecting element can be configured to arrange the front outer surface of the first plate, in the T-shaped composite, in alignment with a rear outer surface of the third plate, in particular adjacent to one another.

In particular, the coupling element can be configured to mechanically couple an edge of the first plate and an edge of the third plate in the constructed T-shaped composite, such that the front outer surface of the first plate and the rear outer surface of the third plate are arranged, in particular directly, adjacent to one another, and wherein advantageously the front outer surface of the first plate and the rear outer surface of the third plate are aligned flush with one another. In this case, the front outer surface of the first plate can be continued flush with the rear outer surface of the third plate.

In particular, at least a part of the first contact surface of the connecting element can be mechanically coupled to the rear outer surface of the first plate by means of a surface adhesive bond and/or a screw connection. Alternatively or additionally, the second contact surface of the connecting element can be mechanically coupled to the rear outer surface of the second plate by means of a surface adhesive bond and/or a screw connection. Advantageously, the surface adhesive bond can be carried out using a liquid adhesive and/or an adhesive tape.

Furthermore, the connecting element can be designed, in particular based on a shaping and/or resilient properties of the coupling element and/or resilient properties of the respective contact surfaces, to form a joint that is as narrow as possible, or a zero joint, between the front outer surface of the first plate and the front outer surface of the third plate.

Advantageously, by means of the connecting element, an edge of the front outer surface of the first plate and an edge of the rear outer surfaces of the third plate can be arranged linearly adjacent to one another, and in particular come into direct contact at points of the joined edge outer surfaces.

In this case, a respective edge surface of the respective plates can be inclined at right angles to the respective outer surface or at an angle to the front outer surface. In particular, the angles of the edge surfaces with the respective outer surfaces can be shaped complementarily to each other in order to establish full-surface contact of the edge of the first plate with the edge of the second plate when the T-shaped composite is constructed.

The connecting element can be shaped according to an elongate profile strip in order to extensively couple an extended first plate to an extended second plate in a respective edge region.

The composite of the T-shaped coupled plates can form a three-wing structure based on the three plates, in which edges of the three plates are coupled to one another, in particular based on the coupling by means of the connecting element, in such a way that in a cross-section through the composite, which is perpendicular to a connecting axis of the abutting edges of the three plates, the three plates are arranged in a T-shape. In particular, the first plate and the third plate, or the front outer surface of the edges, may be directly adjacent to each other, and their front outer surface may be aligned flush with each other. The second plate can be arranged in the T-shaped composite perpendicularly to both the first plate and the third plate.

The respective plate or plate element may have a front outer surface and a rear outer surface, it being possible for the outer surfaces to extend parallel to an extension of the respective plate. The rear outer surface of the first plate and the second plate may be defined by an outer surface to which the connecting element is mechanically coupled.

The coupling element can be designed such that the first contact surface and the second contact surface are outer surfaces of the coupling element. Alternatively or additionally, the coupling element may have tabs that are mechanically connected to the coupling element. In this case, the tabs can be configured so that they can be mechanically coupled to the first plate and/or the second plate according to a respective contact surface.

According to one aspect, it is proposed that the connecting element has a first tab and/or a second tab, the first tab and/or the second tab being mechanically coupled to the coupling element, and the first tab forming a part of the first contact surface and/or the second tab forming a part of the second contact surface.

In this case, the first tab can be configured to mechanically couple a rear outer surface of the first plate to the connecting element. Furthermore, the second tab can be configured to mechanically couple a rear outer surface of the second plate to the connecting element. The coupling element can be mechanically coupled to the first tab and the second tab.

The connecting element can be arranged in the T-shaped composite of three plates in one of the two grooves of the plates, so that the other two views of the T-shaped composite can represent visible surfaces.

For example, the connecting element can be designed to be resilient, so that by coupling the respective contact surface with the respective plates, an elastic deformation of the connecting element takes place, so that the positive connection of the front outer surface of the first plate with the rear outer surface of the third plate is established. In particular, before coupling to the respective plates, the coupling element of the connecting element can have, in a cross-sectional view perpendicular to an extension of the edges of the plates meeting one another in the T-shaped assembly, a parallelogram, which is shaped such that in the construction of the T-shaped composite a torque of the first plate relative to the second plate results in the positive connection of the front outer surface of the edge of the first plate with the rear outer surface of the edge of the third plate. This is because in the construction of the T-shaped composite of the three plates, the elastically deformable coupling element can be deformed so that it is rectangular.

Advantageously, with this T-shaped composite, the front outer surface of the edge of the first plate and the front outer surface of the edge of the third plate can be directly adjacent to each other in order to form the smallest possible joint between the two plates.

In addition, this composite can ensure that the corner between the front outer surface of the second plate and the front outer surface of the third plate is formed by the web. This allows two views of the T-shaped composite of the three plates to be designed as visible surfaces in which the connecting element is concealed.

In particular, the web can be configured to generate a torque between the third plate and the second plate based on a resilient tension of the web, which torque supports the positive connection of the front outer surface of the edge of the first plate with the rear outer surface of the edge of the third plate.

According to one aspect, it is proposed that the coupling element is configured to establish the positive connection between the front outer surface of the edge of the first plate and the rear outer surface of the edge of the third plate by means of elastic deformation of the first contact surface; and/or elastic deformation of the second contact surface; and/or by means of elastic deformation of the coupling element; and/or by means of a two-part construction of the coupling element, the elastic deformation being based on a construction of the T-shaped composite.

In particular, the coupling element can be configured, based on a shape elasticity of the coupling element and/or based on a shape elasticity of the respective contact surface, to cause a torque between the second plate and the first plate in order to effect the positive connection of the front outer surface of the edge of the first plate with the rear outer surface of the edge of the third plate when the T-shaped composite is constructed.

In this case, the torque can result from a deformation of the coupling element and/or a deformation of the respective contact surface during the construction of the T-shaped composite, and in particular the torque can be directed in such a way that the positive connection of the front outer surface of the edge of the first plate with the rear outer surface of the edge of the third plate is supported.

Particularly advantageously, the connecting element can have a first tab and/or a second tab. In this case, the first tab can be configured to mechanically couple the rear outer surface of the first plate to the connecting element. Alternatively or additionally, the second tab may be configured to mechanically couple the rear outer surface of the second plate substantially at right angles by means of the connecting element. In this case, the coupling element is mechanically coupled to the first tab and the second tab.

Advantageously, the second plate and the third plate can comprise a layered composite plate or sandwich plate, or can be designed as a layered composite plate or sandwich plate. In particular, the web can be formed based on a common and connecting cover layer of the front outer surface of the respective layered composite plate of the second plate and the third plate.

For example, the layered composite plate may have thin outer cover layers compared to the plate thickness, which are coupled together via a light intermediate layer to form the plate or a plate element. In this case, the intermediate layer can, for example, have a honeycomb structure.

Advantageously, the second plate and the third plate can be manufactured from an originally common plate by separating an, in particular rear, cover layer and an intermediate layer of the original plate at a location where the web is to be formed. Then the web that couples the second plate to the third plate can be formed by bending both the resulting second plate and third plate

According to one aspect, it is proposed that the connecting element and/or the coupling element is formed in two parts. In this case, a first partial element of the coupling element can have a curved tongue, and a second partial element of the coupling element can have an arcuate recess, in particular shaped corresponding to the curved tongue. The first partial element and the second partial element can be designed to cooperate when the partial elements are pivoted into one another, in particular for the construction of the T-shaped composite, in such a way that an end position of the pivoting, in particular when the T-shaped composite is constructed, is defined by the front outer surface of the edge of the first plate and the rear outer surface of the edge of the third plate abutting against one another, in particular in order to form the narrowest possible joint between the front outer surface of the first plate and the rear outer surface of the third plate.

That is to say that the first partial element and the second partial element are designed in such a way that the two partial elements do not reach an end position due to their respective structure and/or their interaction, but rather are designed in such a way that the end position of the pivoting during the construction of the T-shaped composite is defined by means of the plates coupled to the respective partial elements.

In particular, the connecting element can be designed to form a so-called zero joint at a contact surface of the positive connection between the front outer surface of the edge of the first plate and the rear outer surface of the edge of the third plate.

The first partial element and the second partial element can form the connecting element by means of pivoting. In particular, the first partial element and the second partial element can be connected to form the connecting element by the first partial element and the second partial element interlocking by pivoting the partial elements into one another, based on a positive connection of complementary shapes of the curved tongue and the arcuate recess formed corresponding to the curved tongue.

In other words, the two-part connecting element or the two-part coupling element can also be used to construct the T-shaped composite of the plates. In this case, the first contact surface is configured to mechanically couple a rear outer surface of the first plate to the connecting element. Furthermore, the second contact surface is configured to mechanically couple a rear outer surface of the second plate to the two-part connecting element.

The one-piece connecting element or the two-part connecting element can be used in particular in furniture construction and vehicle construction.

By means of the one-piece or two-part connecting element, the plates, such as layered composite plates, can be coupled together in a T-shaped composite in such a way that the front outer surface at the edge of the first plate abuts against the rear outer surface at the edge of the third panel in a practically joint-free manner, so that substantially a zero joint is formed in particular between these two plates. In this case, these two plates can be arranged adjacent to each other in the T-shaped composite with almost no gaps or overhangs.

In particular, the first partial element may have the first contact surface and be configured to couple to a rear outer surface of the first plate by means of the first contact surface. The second partial element may have the second contact surface and be configured to mechanically couple to the rear outer surface of the second plate in order to establish the positive connection of the front outer surface of the edge of the first plate with the rear outer surface of the edge of the third plate when the third plate is mechanically coupled by means of the web which connects the rear outer surface of the third plate to a front outer surface of the second plate.

According to one aspect, it is proposed that the first partial element has a tongue which is curved in cross-section. In this case, the second partial element can have an arcuate recess in a cross-section, in particular shaped corresponding to the arcuate tongue. The two partial elements can be designed in such a way that by connecting the first partial element to the second partial element in the end position of the pivoting, the mutual positive connection of the front outer surface of the edge of the first plate with the rear outer surface of the edge of the third plate is formed.

In particular, the two partial elements can be designed in such a way that by pivoting the first partial element relative to the second partial element in an end position of the pivoting, a mutual positive connection of the respective partial elements of the coupling element is formed, in order to particularly advantageously connect and/or couple the two partial elements to one another.

In other words, the first partial element in the form of a profile strip and the second partial element in the form of another profile strip can be coupled to the first plate and the second plate, respectively. By means of a pivoting or rotational movement, which is predetermined by the shaping of the curved tongue of the first partial element and the shaping of the curved recess of the second partial element, the pivoting can be guided, and the front outer surface of the edge of the first plate and the rear outer surface of the edge of the third plate can be butted substantially to a zero joint. In addition, the pivoting of the partial elements leads to a positive connection of the partial elements and thus a coupling of the first plate with the second plate.

In particular, the shaping of the curved tongue and/or the curved recess can be designed to bring about a mutual positive connection of the respective partial elements in a direction perpendicular to the first plate. For this purpose, the curved tongue can form a concave, in particular circular-cylindrical-segment-shaped, engagement surface on a surface of the tongue. In addition, the curved recess can form a convex, in particular circular-cylindrical-segment-shaped, engagement surface on a surface of the recess for the mutual positive connection, it being possible for the engagement surfaces to be arranged adjacent to one another in the end position of the pivoting in order to effect the mutual positive connection.

According to one aspect, it is proposed that the first partial element of the coupling element and/or the second partial element of the coupling element are configured to cooperate, in particular by means of a locking device, in order to lock the two partial elements in the end position of the pivoting when the partial elements are connected.

Advantageously, the first partial element and the second partial element can be configured, by means of a latching connection, to lock the two partial elements in the end position of the pivoting.

For example, the first partial element can have a latching hook of the latching connection and the second partial element can have a notch of the latching connection shaped corresponding to a shape of the latching hook, in order to lock the first partial element and the second partial element by means of the latching connection.

Advantageously, the tongue of the first partial element and the recess of the second partial element can be configured to cooperate in order to act for the pivoting of the first partial element relative to the second partial element according to an axis of rotation, so that when the first partial element, which is in particular coupled to the second plate, pivots relative to the second partial element, which is in particular coupled to the first plate, the front outer surface of the edge of the first plate creates the positive connection with the rear outer surface of the edge of the third plate.

In particular, in this way the front outer surfaces of the plates can be arranged directly adjacent to one another and/or flush.

In this case, a center point of this axis of rotation can lie outside the connecting element and pivoting of the partial elements with respect to this axis of rotation can cause a joint or a gap between the edge of the front outer surface of the first plate and the edge of the rear outer surface of the third plate to be reduced, so that in the end position of the pivoting the joint is closed.

In particular, the latching hook of the first partial element and the notch of the second partial element can be configured to form a resiliently coupled latching connection based on an interaction of the curved tongue of the first partial element and the curved recess of the second partial element complementary to the tongue. For this purpose, an engagement surface on a surface of the curved tongue can act resiliently on a surface of the recess by deforming the curved tongue in order to insert the latching hook sufficiently deeply into the recess and to lock it by means of the resilient effect.

Advantageously, the second partial element can have a cavity on a side of a receiving space, opposite the notch, for the latching hook in the second partial element in order to non-releasably lock the latching connection in a locked position of the latching connection by means of a cured adhesive which fills the cavity.

In particular, the first partial element and/or the second partial element can be configured to fix the two partial elements in the end position of the pivoting by means of an adhesive bond between the first partial element and the second partial element.

Particularly advantageously, the first partial element can have a positioning stop and the second partial element can have a corresponding positioning receptacle in order to form a positioning device for pivoting for connecting the first partial element to the second partial element.

According to a further aspect, it is proposed that the connecting element is designed in the form of an elongate profile strip, in particular in order to mechanically couple an extending edge of the first plate and an extending edge of the second plate.

A connecting element, according to the above description, for constructing a T-shaped composite of three plates is proposed. In this case, the connecting element has a first contact surface, a second contact surface and a coupling element. The first contact surface of the connecting element is configured to be mechanically coupled to a rear outer surface of a first plate of the three plates. The second contact surface of the connecting element is configured to be mechanically coupled to a rear outer surface of a second plate of the three plates. The coupling element is mechanically coupled to the first contact surface and the second contact surface. In this case, the coupling element is designed in two parts with a first partial element and a second partial element. The first partial element, which in particular has a curved tongue, and the second partial element, which in particular has a recess corresponding to a shape of the tongue, are designed to cooperate when the joined partial elements are pivoted in such a way that a positive connection of a front outer surface of an edge of the first plate with a rear outer surface of an edge of a third plate results. For this purpose, the third plate can be mechanically coupled by means of a web which connects a front outer surface of the third plate to a front outer surface of the second plate, in particular in an angled manner. This makes it possible, in particular, to arrange the front outer surface of the first plate in the T-shaped composite in alignment with a rear outer surface of the third plate, in particular with the respective edges adjacent to one another.

A T-shaped composite of three plates, with a connecting element according to the above description, a first plate, a second plate and a third plate is proposed.

A rear outer surface of the first plate is mechanically coupled to a first contact surface of the connecting element of the connecting element.

A rear outer surface of the second plate is mechanically coupled to a second contact surface of the connecting element.

The front outer surface of the third plate is mechanically coupled, in particular angled, to a front outer surface of the second plate by means of a web. In particular, the third plate is arranged at an angle relative to the second plate, preferably substantially at a right angle. In this case, the connecting element is arranged and configured to arrange, in the T-shaped composite, the front outer surface of the first plate in alignment with a rear outer surface of the third plate, in particular adjacent to one another.

A use of a connecting element as described above for the T-shaped coupling of three plates is proposed, in particular a second and a third panel being layered composite panels and/or sandwich panels.

### BRIEF DESCRIPTION OF THE DRAWINGS

The invention has been explained by way of example in the present description.

It can be modified in many ways. Different elements or features of the individual embodiments can also be combined with one another.

In the figures:

FIG. 1: is a schematic view of a connecting element;

FIG. 2: is a schematic view of a further connecting element;

FIG. 3: is a schematic view of a first partial element of the further connecting element coupled to a second plate;

FIG. 4: is a schematic view of a second partial element of the further connecting element coupled to a first plate; and

FIG. 5: is a schematic view of a construction of the T-shaped composite.

### DETAILED DESCRIPTION

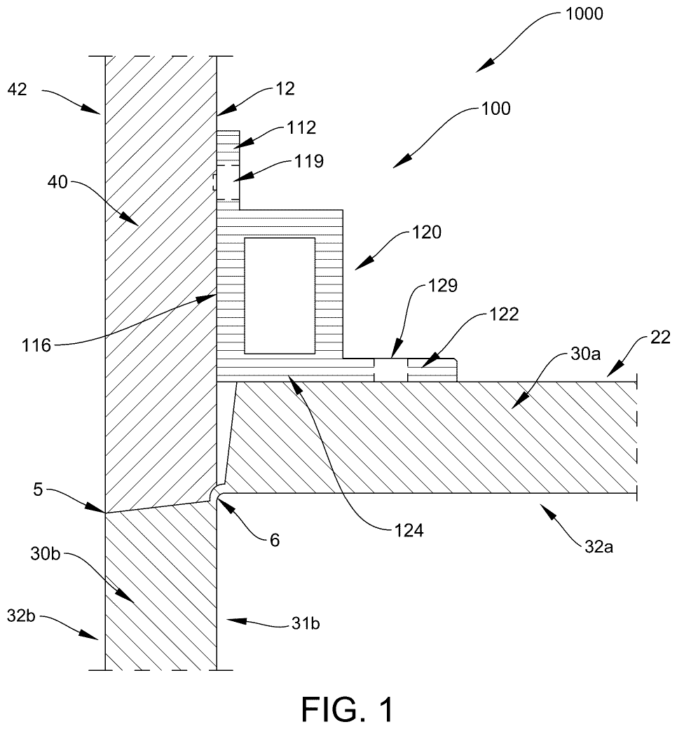

FIG. 1 schematically outlines a connecting element 100 for constructing a T-shaped composite 1000 of three plates 30a, 30b, 40, the connecting element 100 having a first contact surface 116, a second contact surface 124 and a coupling element 120. In this case, the first contact surface 116 of the connecting element 100 is configured to be mechanically coupled to a rear outer surface 12 of a first plate 40 of the three plates 30a, 30b, 40. Furthermore, the second contact surface 124 of the connecting element 100 is configured to be mechanically coupled to a rear outer surface 22 of a second plate 30a of the three plates 30a, 30b, 40. The coupling element 120 is mechanically coupled to the first contact surface 116 and the second contact surface 124. The coupling element 120 is configured to mechanically couple the first plate 40 to the second plate 30a by means of the first contact surface 116 and the second contact surface 124, in particular substantially at right angles. Furthermore, the coupling element 120 is configured to produce a positive connection between an edge of a front outer surface 42 of the first plate 40 and an edge of a rear outer surface 32b of a third plate 30b, in particular at a joint 5, when the third plate 30b is mechanically coupled by means of a web 6 which connects a front outer surface 31b of the third plate 30b to a front outer surface 32a of the second plate 30a, in particular in an angled manner.

The front outer surface 42 of the first plate 40 can, by means of the connecting element in the constructed T-shaped composite, continue a rear outer surface 32b of the third plate 30b such that these surfaces 42, 32b are arranged flush with one another and aligned with one another.

The second plate 30a and the third plate 30b can be designed according to a layered composite plate or sandwich plate. In particular, the web 6 can be formed based on a common and connecting cover layer of the front outer surface 32a of the second plate 30a and the front outer surface 31b of the third plate 30b.

Edge surfaces of the respective plates 40, 30b abutting against the joint 5 can be inclined at right angles to the respective outer surface 42, 32b or at an angle to the aligned outer surface 42, 32b. In particular, the angles of the edge surfaces with the respective outer surfaces 42, 32b can be shaped complementarily to one another in order to establish full-surface contact of the edge of the first plate 40 with the edge of the second plate 30b when the T-shaped composite is constructed.

The coupling element 120 can be configured such that the first contact surface 116 and the second contact surface 124 are outer surfaces of the coupling element 120. Alternatively or additionally, the coupling element 120 may have a first tab 112 and/or a second tab 122 which are mechanically connected to the coupling element 120. In this case, the first tab 112 and the second tab 122 can be configured such that they can be mechanically coupled to the first plate 40 and/or the second plate 30a corresponding to the first contact surface 116 and the second contact surface 124, respectively. In particular, the first tab 112 may form part of the first contact surface 116 and/or the second tab 122 may form part of the second contact surface 124. The first tab 112 can be mechanically coupled to the first plate 40 through a bore 119 by means of a screw connection and/or by means of an adhesive connection. The second tab 122 can be mechanically coupled to the second plate 30a through a bore 129 by means of a screw connection and/or by means of an adhesive connection.

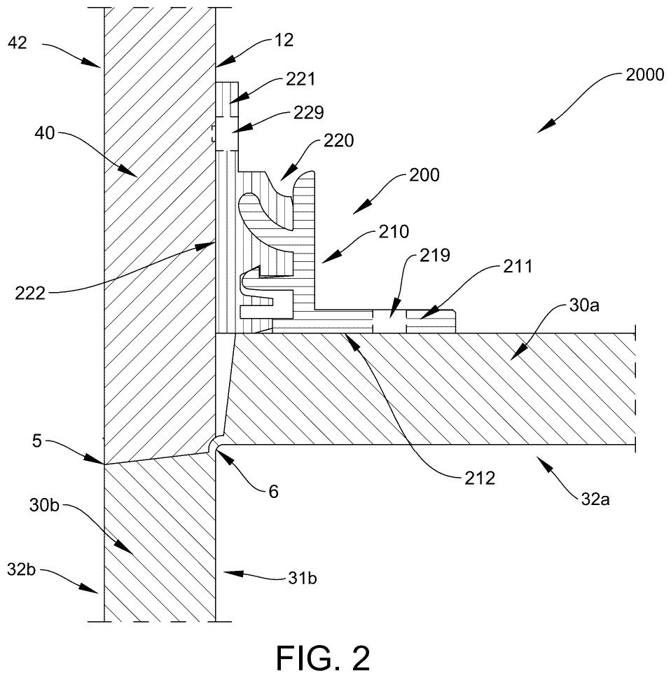

FIG. 2 schematically outlines a connecting element 200 for constructing a T-shaped composite of three plates 30a, 30b, 40, such as layered composite plates or sandwich plates, corresponding to the one-piece connecting element 100 described above, in which the connecting element or the coupling element is designed in two parts. In this case, the two-part connecting element 200 can be coupled to the three plates 30a, 30b, 40, as described for the one-piece connecting element 100 in FIG. 1.

The two-part connecting element 200 may comprise a two-part coupling element with a first partial element 210 and a second partial element 220. In this case, the first partial element 210 can have a curved tongue and the second partial element 220 can have an arcuate recess, in particular shaped corresponding to the curved tongue. The first partial element 210 and the second partial element 220 can be designed to interact when the partial elements 210, 220 are pivoted into one another, in particular for the construction of the T-shaped composite 2000, in such a way that an end position of the pivoting, in particular when the T-shaped composite 2000 is constructed, is defined by the edge of the front outer surface 42 of the first plate 40 and the edge of the rear outer surface 32b of the third plate 30b abutting against one another. This makes it possible to form the narrowest possible joint between the edge of the front outer surface 42 of the first plate 40 and the edge of the rear outer surface 32b of the third plate 30b.

The front outer surface 42 of the first plate 40 can continue the rear outer surface 32b of the third plate 30b by means of the connecting element 200, so that these outer surfaces 42, 32b abut one another flush and are aligned with one another.

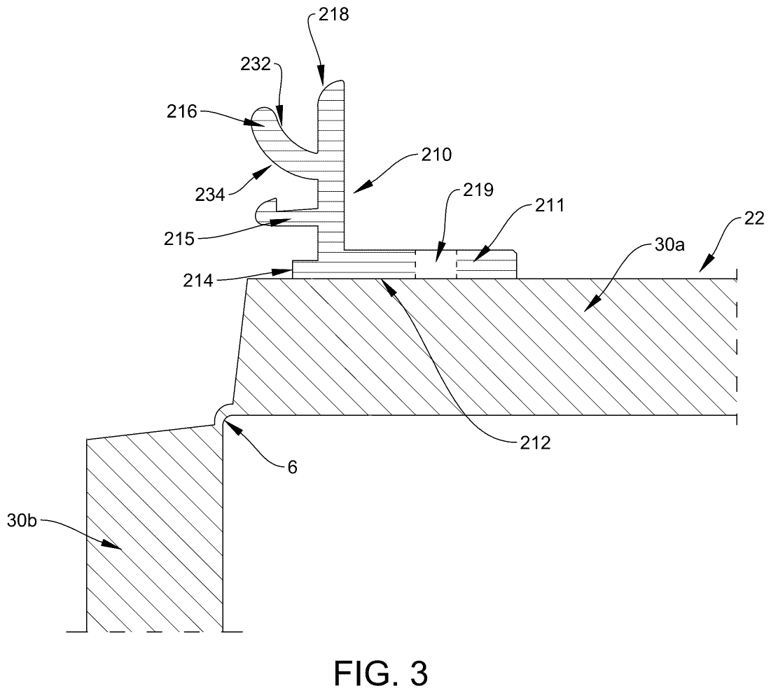

FIG. 3 schematically outlines the first partial element 210 of the two-part connecting element 200, the mechanical coupling of which with the second plate 30a and the coupling of the second plate 30a with the third plate 30b by means of the web 6 was described above. In this case, the first partial element 210 has the first tab 211, which is configured to mechanically couple a rear outer surface 12 of the second plate 30a to the connecting element 200 or to the first partial element 210, as described in relation to FIG. 2. The first tab 211 can mechanically couple the first partial element 210 to the second plate 30a for example by means of a screw that is passed through an opening 219 of the first tab 211.

The stop 214 of the first partial element 210 can be set back relative to the stop 8 to such an extent that the end position of the pivoting of the two partial elements 210, 220 relative to one another is defined by the front outer surface 42 of the edge of the first plate 40 and the rear outer surface 32b of the edge of the third plate 30b abutting against one another.

The first partial element 210 can have a tongue 216 which is curved in a cross-section and which is designed to cooperate with a recess of the second partial element which is curved in a cross-section, in order to form a mutual positive connection of the respective partial elements when the first partial element 210 is brought together and pivoted relative to the second partial element 220 in an end position of the pivoting.

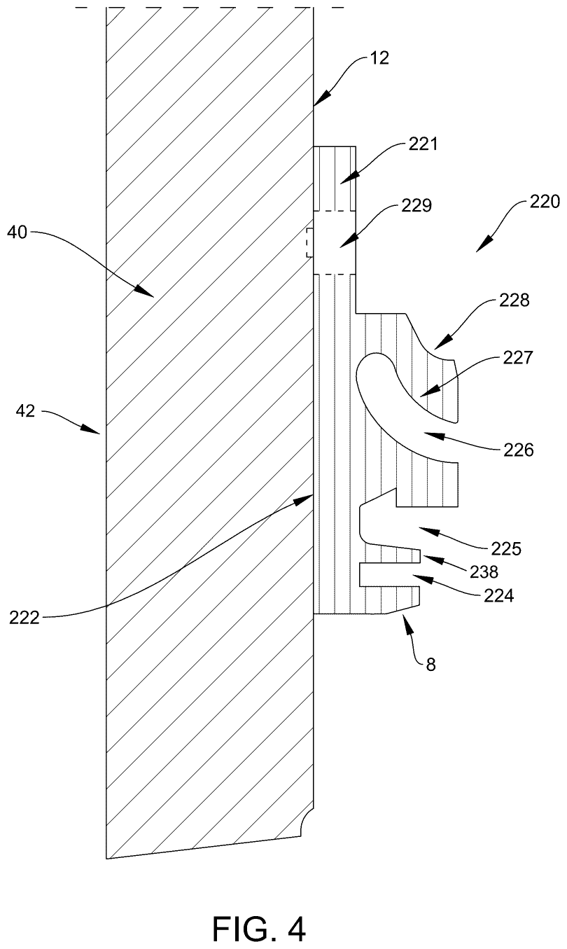

In particular, the shaping of the curved tongue 216 and the curved recess (226 of FIG. 4) can be configured to effect a mutual positive connection of the respective partial elements 210, 220 in a direction perpendicular to the rear outer surface 12 of the first plate 40. For this purpose, the curved tongue can form a concave, in particular circular-cylindrical-segment-shaped, engagement surface 232 on a surface of the tongue 216. In addition, the curved recess (226 of FIG. 4) can form a convex, in particular circular-cylindrical-segment-shaped, engagement surface (227 of FIG. 4) on a surface of the recess (226 of FIG. 4) for the mutual positive connection, it being possible for the engagement surfaces to be arranged adjacent to one another in the end position of the pivoting in order to effect the mutual positive connection.

The first partial element 210 can be configured to interact with the second partial element 220 by means of a latching connection 215, 226 in order to lock the two partial elements 210, 220 in the end position of the pivoting when the partial elements 210, 220 are pivoted. For this purpose, the first partial element 210 can have a latching hook 215 of the latching connection, which is configured to cooperate with a notch of the latching connection of the second partial element 220 corresponding to a shape of the latching hook, in order to lock the first partial element 210 and the second partial element 220 by means of the latching connection.

The first partial element may have a positioning stop 218 which is configured to cooperate with a corresponding positioning receptacle 228 of the second partial element 220 in order to form a positioning device for the subsequent pivoting when joining the first partial element 210 and the second partial element 220.

FIG. 4 schematically outlines the second partial element 220 of the two-part connecting element 200, the mechanical coupling of which to the second plate 30a and the coupling of the second plate 30a to the third plate 30b by means of the web 6 was described above.

In this case, the second partial element 220 has the second tab 221, which is configured to mechanically couple a rear outer surface 12 of the first plate 40 to the connecting element 200 or to the second partial element 220, as described for FIG. 2. The second tab 221 can be mechanically coupled to the first plate 40, for example by means of a screw that is passed through an opening 229 of the second tab 221.

The second partial element 210 may have a recess 226 which is curved in cross-section and is configured to cooperate with a tongue 216 of the first partial element which is curved in cross-section in order to form a mutual positive connection of the respective partial elements when the first partial element 210 is brought together and/or pivoted relative to the second partial element 220 in an end position of the pivoting.

The second partial element 220 can be configured to interact with the first partial element 210 by means of a latching connection 215, 225 in order to lock the two partial elements 210, 220 in the end position of the pivoting when the partial elements 210, 220 are pivoted. For this purpose, the second partial element 210 can have a notch 255 of the latching connection, which is designed to cooperate with a shape of the latching hook of the latching connection of the first partial element 210 corresponding to a shape of the notch, in order to lock the first partial element 210 and the second partial element 220 by means of the latching connection 215, 225.

The second partial element may have a positioning receptacle 228 which is configured to cooperate with a corresponding positioning stop 218 of the first partial element 220 in order to form a positioning device for the subsequent pivoting for joining the first partial element 210 and the second partial element 220.

The second partial element 220 may have a cavity 224 on a side of the receiving space for the latching hook 215 opposite the notch, in order to non-releasably lock the latching connection in a latched position of the latching connection by means of a cured adhesive that fills the cavity 224.

The second partial element 220 may have a web 238 which guides the latching hook 215 into the notch 225 for locking the latching connection.

The curved tongue 216 of the first partial element 210 and the curved recess 226 of the second partial element 220 can be configured to cooperate in order to pivot the first partial element 210 with the second partial element 220 according to an axis of rotation, so that when the first partial element 210, which is coupled in particular to the second plate 30a, pivots relative to the second partial element 220, which is coupled in particular to the first plate 40, the front outer surface 42 of the edge of the first plate 40 establishes the positive connection with the rear outer surface 32b of the edge of the third plate 30b.

Advantageously, the tongue of the first partial element and the recess of the second partial element can be configured to cooperate in order to act for the pivoting of the first partial element relative to the second partial element according to an axis of rotation, so that when the first partial element, which is in particular coupled to the second plate, pivots relative to the second partial element, which is in particular coupled to the first plate, the front outer surface of the edge of the first plate creates the positive connection with the rear outer surface of the edge of the third plate.

In this case, a center point of this axis of rotation can lie outside the connecting element 200 and pivoting of the partial elements 210, 220 with respect to this axis of rotation can cause a joint 5 or a gap 5 between the edge of the front outer surface 42 of the first plate 40 and the edge of the rear outer surface 32b of the third plate 30b to be reduced, so that in the end position of the pivoting the joint 5 is closed. This makes it possible, in particular, to arrange the front outer surface 42 of the first plate 40 in the T-shaped composite 2000 in alignment with a rear outer surface 32b of the third plate 30b, in particular with the respective edges adjacent to one another and in particular forming the joint 5.

A shape of the curved recess 226 may correspond to a shape of the curved tongue 216 to accommodate the curved tongue 216 in the curved recess by means of the pivoting.

The latching hook 215 of the first partial element 210 and the notch 225 of the second partial element 220 can be configured to form a resiliently coupled latching connection based on an interaction of the curved tongue 260 of the first partial element 210 by means of the engagement surface 234 acting on an engagement surface of the curved recess of the second partial element 220.

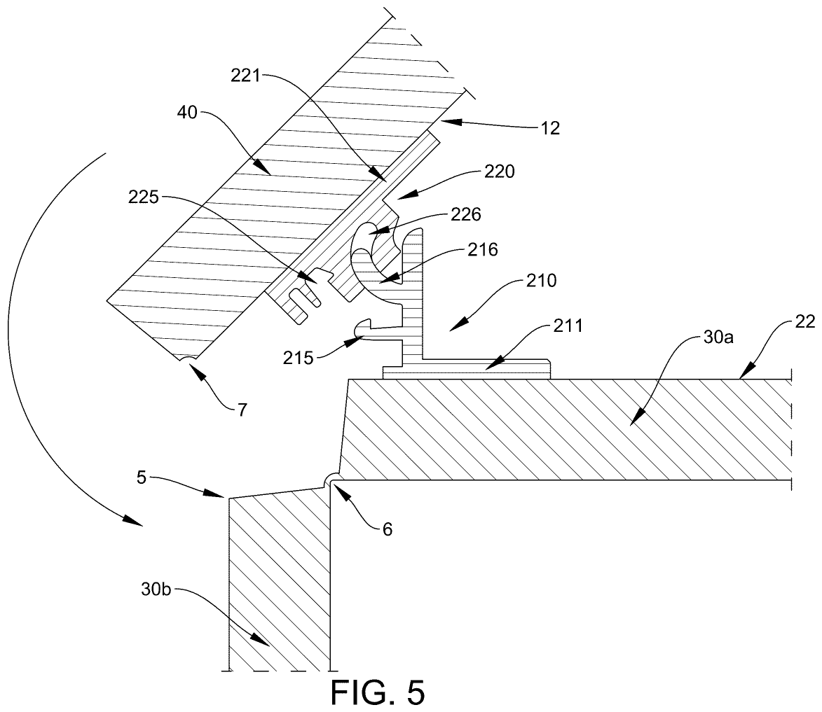

FIG. 5 schematically outlines a structure of a T-shaped composite 2000 of three plates 40, 30a, 30b with a pivoting of the partial elements 210, 220 into one another, the end position of the pivoting being defined by the abutment of the front outer surface of the edge of the first plate 40 and the rear outer surface of the edge of the third plate 30b in order to produce a positive connection between the front outer surface of an edge of the first plate 40 and a rear outer surface of an edge of a third plate 30b at the joint 5. During pivoting, the first partial element 210 is coupled to the second plate 30a and the second partial element 220 is coupled to the first plate 40. A recess 7 at the edge of the rear outer surface 12 of the first plate 40 makes it possible to avoid the web 6 preventing the joint 5 from closing during pivoting.

1. A connecting element for constructing a T-shaped composite of three plates, comprising:
a first contact surface configured to be mechanically coupled to a rear outer surface of a first plate;
a second contact surface configured to be mechanically coupled to a rear outer surface of a second plate; and
a coupling element which is mechanically coupled to the first contact surface and the second contact surface,
wherein the coupling element is configured to mechanically couple the first plate to the second plate by the first contact surface and the second contact surface, in an angled manner; and
wherein the coupling element is configured to produce a positive connection between a front outer surface of an edge of the first plate and a rear outer surface of an edge of a third plate, when the third plate is mechanically coupled by a web which connects a front outer surface of the third plate to a front outer surface of the second plate, in order to arrange the front outer surface of the first plate in alignment with a rear outer surface of the third plate in the T-shaped composite.

2. The element according to claim 1, wherein the coupling element is configured to establish the positive connection between the front outer surface of the edge of the first plate and the rear outer surface of the edge of the third plate by elastic deformation of the first contact surface; and/or by elastic deformation of the second contact surface; and/or by elastic deformation of the coupling element; and/or by a two-part construction of the coupling element, wherein the elastic deformation is based on a construction of the T-shaped composite.

3. The connecting element according to claim 1, wherein the coupling element, based on a shape elasticity of the coupling element and/or based on a shape elasticity of the respective contact surface, is configured to cause a torque between the second plate and the first plate in order to cause the positive connection of the front outer surface of the edge of the first plate with the front outer surface of the edge of the third plate when the T-shaped composite is constructed.

4. The connecting element according to claim 1, wherein the second plate and the third plate comprise a layered composite plate or sandwich plate; and the web is formed based on a common and connecting cover layer of the respective layered composite plate of the second plate and the third plate.

5. The connecting element according to claim 1, wherein the connecting element and/or the coupling element is formed in two parts, and a first partial element of the coupling element has a curved tongue; and a second partial element of the coupling element has an arcuate recess, in particular shaped to correspond to the curved tongue; wherein the first partial element and the second partial element are designed to cooperate when the partial elements pivot into one another such that an end position of the pivoting is defined by the front outer surface of the edge of the first plate and the rear outer surface of the edge of the third plate abutting against one another.

6. The connecting element according to claim 5, wherein the first partial element has the curved tongue in a cross-section; and wherein the second partial element has the arcuate recess in a cross-section; and the first partial element and the second partial element is designed such that by connecting the first partial element to the second partial element in the end position of the pivoting, the mutual positive connection of the edge of the front outer surface of the first plate with the edge of the rear outer surface of the third plate is formed.

7. The connecting element according to claim 5, wherein the first partial element of the coupling element and/or the second partial element of the coupling element are configured to cooperate in order to lock the first partial element and the second partial element in the end position of the pivoting when connecting the first partial element and the second partial element.

8. The connecting element according to claim 7, wherein the first partial element and the second partial element are configured by a latching connection to lock the first partial element and the second partial element in the end position of the pivoting.

9. The connecting element according to claim 8, wherein the first partial element has a latching hook of the latching connection; and the second partial element has a notch of the latching connection shaped to correspond to a shape of the latching hook in order to lock the first partial element and the second partial element by the latching connection.

10. The connecting element according to claim 9, wherein the curved tongue of the first partial element and the arcuate recess of the second partial element are configured to cooperate to act for the pivoting of the first partial element relative to the second partial element according to an axis of rotation, so that when the first partial element pivots relative to the second partial element, the front outer surface of the edge of the first plate establishes the positive connection with the rear outer surface of the edge of the third plate.

11. The connecting a element according to claim 9, wherein the second partial element has a cavity on a side of a receiving space for the latching hook in the second partial element opposite the notch in order to non-releasably lock the latching connection in a latched position of the latching connection by a cured adhesive which fills the cavity.

12. The connecting element according to claim 5, wherein the first partial element has a positioning stop and the second partial element has a corresponding positioning receptacle in order to form a positioning device for the pivoting for connecting the first partial element to the second partial element.

13. The connecting element according to claim 1, wherein the connecting element is designed in the form of an elongate profile strip to mechanically couple an extending edge of the first plate and an extending edge of the second plate.

14. A connecting element for constructing a T-shaped composite of three plates, comprising:
a first contact surface configured to be mechanically coupled to a rear outer surface of a first plate;
a second contact surface configured to be mechanically coupled to a rear outer surface of a second plate; and
a coupling element coupled to the first contact surface and the second contact surface;
wherein the coupling element is formed in two parts; and the coupling element is configured by a first partial element, which has a curved tongue, and a second partial element, which has a arcuate recess corresponding to a shape of the curved tongue, to cooperate upon pivoting of the partial elements moved together in such a way that a positive connection of an edge of a front outer surface of the first plate with an edge of a rear outer surface of a third plate results when the third plate is mechanically coupled by a web which connects a front outer surface of the third plate with a front outer surface of the second plate, in an angled manner, in order to arrange the front outer surface of the first plate in alignment with the rear outer surface of the third plate, adjacent to one another, in the T-shaped composite.

15. (canceled)
